(19) United States
(12) Patent Application Publication
(10) Pub. No.: US 2012/0303516 A1
(43) Pub. Date: Nov. 29, 2012

(54) DONATION AND PAYMENT SYSTEM

(76) Inventors: Zalman Fellig, Coconut Grove, FL (US); Javier Sztabzyb, Brooklyn, NY (US)

(21) Appl. No.: 13/208,849

(22) Filed: Aug. 12, 2011

Related U.S. Application Data
(60) Provisional application No. 61/373,102, filed on Aug. 12, 2010.

(51) Int. Cl. G06Q 20/10

(52) U.S. Cl. 705/39

(57) ABSTRACT

An economically viable virtual payment system and method for creating and processing donations and payments, even for micro donation payments to a Merchant, which operates on any of multiple electronic communications platforms e.g., PC, Apple, Linux and platforms such as BlackBerry OS, iPhone OS, Windows Mobile and Google Android and through the world wide web and mobile web. Micro donation payments are cumulated in a virtual money receptacle up to a pre-determined amount which triggers electronic transfer of the cumulated funds to the Merchant.

### FIELD OF THE INVENTION

This invention relates to systems for the processing of micro deposits (e.g., $0.25, $1 etc.) and general deposits, donations and payments, and particularly to such deposits made electronically such as with PC, Apple, Linux based devices and by using platforms such as BlackBerry OS, iPhone OS, Windows Mobile and Google Android and through the world wide web and mobile web.

### BACKGROUND OF THE INVENTION

There are currently two options for processing payments and making micro deposits (generally ranging from coin denominations and up to several dollars) and/or making payments and deposits. These options are physical payments and electronic payments with such payments effected either offline (not involving a communication system) and online (involving an electronic communication system). These systems and operations encompass:

### Offline:

Processing of micro deposits for a Merchant (defined herein as funds collected/processed and then distributed to the charity, organization or merchant (“Merchant”)) and individuals, is restricted to collecting funds in a physical receptacle similar to an offering plate commonly found in a church or a “pushka” (charity box) in a synagogue. Congregants and individuals place small amounts of money into the receptacle as the “micro deposit. Similarly, individuals, seeking to save money for a college fund, rainy day fund or similar objective, drop “micro deposits” into a “piggy bank” or similar receptacle.

General payments, usually of a more substantial monetary nature (and not with actual cash), made to merchants or organizations are either processed in person, over the telephone or via mail. With the latter expedients, the Merchant manually inputs the financial data collected from the individual into a credit card processing terminal or similar device, to process the payment.

### Online:

Currently there are online payment gateways, which enable Merchants to process general transactions payments, donations and the like over the web. These services are restrictive in nature and not generally economically amenable to small payments due to the high cost associated with processing micro payments. This restrictive nature has generally resulted in the holding back of the acceptance and processing of micro deposits or payments by Merchants because of economic considerations. However, the current trend and inclination and desire of individuals is to conduct more and more on-line transactions, including micro payments and deposits and to thereby reduce the amount of cash and change transactions. The economic restriction, in not generally accepting micro payments, has resulted in a significant loss to the Merchants.

In addition, online services are restricted generally to one channel e.g., online payment platform versus a mobile web payment platform, thereby further restricting options of making payments and deposits. An all-in-one system that combines cross platform transaction processing, including online, mobile and social media with traditional offline transaction processing is however not available.

Furthermore, with respect to general payments online, Merchants only have access to payment related tools. Integrated accounting, marketing, and reporting capability is not provided or even available. As a result, a Merchant is forced to rely on multiple tools simultaneously in order to fully drive transactions. However, since the various processing services are not integrally related, the process or “flow” of the process causes unnecessary additional steps for the individual consumer, thereby risking the ultimate abandonment of a transaction.

### SUMMARY OF THE INVENTION

It is accordingly an object of the present invention to provide a donation, deposit or payment system, which is configured to be economically viable with respect to electronic payments of a micro nature.

It is a further object of the present invention to provide a system, which is operable across all or nearly all of the communication platforms including the web and all phone OS systems for all types of electronic payments in general.

It is still yet another object of the present invention to provide the system with optional integrated accounting, marketing, and reporting capabilities.

Generally the present invention comprises an economically viable virtual payment system and method for creating and processing payments, even for micro payments to a Merchant (referred to herein for simplicity as a “payment system” or “MyCharityBox”) which operates on any of multiple electronic communications platforms e.g., PC, Apple, Linux and platforms such as BlackBerry OS, iPhone OS, Windows Mobile and Google Android and through the world wide web and mobile web.

The system is configured for the making of payments or donation over multiple platform electronic communication systems, the system comprising the participants of a recipient Merchant, a system server with system administrator and a consumer making payments or donations to the Merchant.

The system comprises a front end relationship between the Merchant and the consumer and a back end relationship between the Merchant and the system server. The back end of the system comprises elements for the Merchant to provide billing and banking data to the system server and wherein the system server in turn creates and provides the Merchant with a unique URL for a web site.

At least one of donation causes, for donation thereto, and available purchasable products, is made available on the web site for access by the consumer with the front end of the system comprising elements to enable the Merchant to promote the system on the web site via any of web, social media, mobile web, iPhone App and mobile App platforms for use by the consumer for making donations or payments with electronic transmissions to the Merchant with any one of the web, social media, mobile web, iPhone App and mobile App platforms.

The consumer provides information to create a profile on the system server to authorize and enable the consumer to access the Merchant web site for utilization of the platforms for making donations and payments and with predetermined criteria being reached, the system server causes funds donated or payment funds made by the consumer to be electronically transferred to the Merchant.

The system comprises a monetary payment and/or donation platform comprising:
a. A profile creation module for setting up a particular Merchant into the system;
b. A Front End module, with the Front End configured as the tool for the public facing of the system, where the individual consumers engage the Merchant and transact the payments and donations;
c. Marketing and promotion capability elements including tools to promote, through social medial websites such as Facebook, LinkedIn and Twitter. Additionally email-marketing tools are integrated within the profile allowing the Merchant to attract potential individual consumers through email,
d. A Back End module or system configured for Profile management, individual consumer (customer) management and Product/Cause management, which will be positioned on the individual consumer “Front End”. The Merchant Back End comprises a unique URL for Merchant access and secured login protocol to access, manage and make changes to the Merchant Profile.
e. System module configured for consumer, client or customer transactions processing with aggregation and recurring payment capability,
f. Transaction system for micro deposit management, and
g. Cross platform system permitting available electronic communication systems, including web and various phone OS protocols, to be utilized for the deposits or payments.

The method of the present invention comprises the steps of setting up an on line web site for a Merchant with configuring the system for accounting and marketing capabilities for use by the Merchant, as well as periodic or on demand reporting. The method further comprises the operative steps of enabling consumers, clients or customers to make electronic donations and payments across multiple platforms, as described, including cumulation of donation micro deposits and the transfer of funds and cumulated funds to the Merchant upon the reaching of predetermined criteria.

Optionally, the system is provided with a token system which utilizes “tokens”, as graphical representations (e.g., coins or paper currency) of payments or donations. The Back End of the system is provided with management tools for a systems administrator and for Merchants.

Other objects, features and advantages of the present invention will become more evident from the following discussion as well as the drawings in which:

### SHORT DESCRIPTION OF THE DRAWING

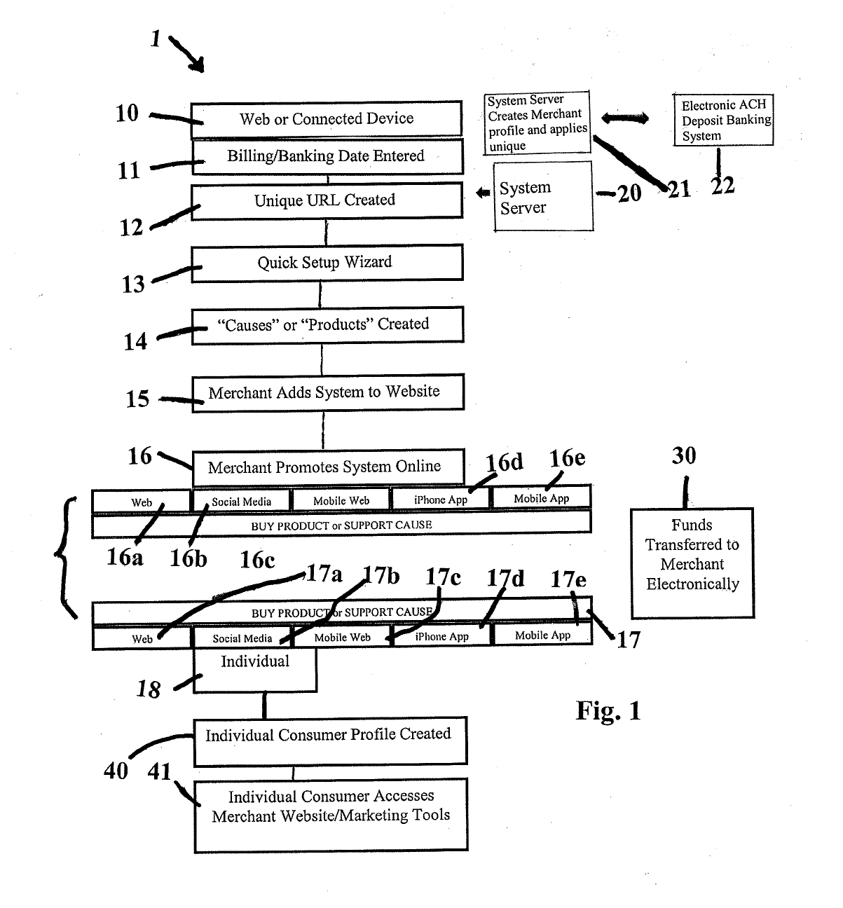

The sole FIG. 1 is a flow chart of the system of the present invention with integration of front end and back end features for “customer”, “Merchant” and “system server”.

### DETAILED DESCRIPTION OF THE INVENTION

With specific reference to the system modules and with respect to: the Merchant, the customer (one making payments and/or donations) and the system administrator, the following are detail specifics of the payment system, including optional features and the steps involved in setting up the system of the invention:

### Merchant

### Process: Initial Profile Creation (Merchant)

Step 1: A Merchant creates a profile through an online data collection form. This form collects the Merchant contact data, Merchant name and requested destination URL. Once this data is submitted, the system server administrator checks for availability of the requested destination URL. If the URL is available, the account is registered and activated and an automated URL, based on the merchant profile request, is generated. The system server creates a Merchant profile with a unique Merchant ID # for further access and to track activity for the Merchant profile.

Step 2: Upon creation of the Merchant ID # and destination URL, the system server redirects the Merchant to its newly created system for account setup and configuration. The Merchant enters a “Quick Setup” module designed to configure main components of the tool for the Merchant's public facing system (“Front End”) where the individual consumer engages the Merchant and transacts actions such as for donations or payments. The Quick Setup comprises content, e.g., photos, videos, blog, social media feeds and product/cause creation. There are generally 9-12 steps taken through this process with the system server directing the Merchant to the next step, upon completion of the previous step. Each step taken populates the corresponding content on the Front End.

Step 3: The Merchant enters its banking deposit information including an electronic ACH Routing number and corresponding account number of the bank account registered to the Merchant and profile. Once the information is entered, the system server sends a query to an internal database of bank routing numbers and verifies the validity of the banking information. An alternative route of verification is through a test deposit into the Merchant bank account. The system server connects via API to an ACH distribution system to process the test deposit, which is equal or less than $1.00.

The present system enables a Merchant to create a profile, to collect and process micro and general transactions. The profile enables the Merchant to create multiple “Causes” or “Products” to which an individual consumer can choose to purchase or donate to by the means of an online transaction. Furthermore the system allows the Merchant to brand the product to needs with setup wizards including e.g., logo, unique messaging, Cause or Product descriptions and Cause or Product updates.

Once a Merchant Profile is set up, the Merchant can begin promoting and Marketing its “Causes” and “Products” immediately. The present system may include tools to promote, through social medial websites such as Facebook, LinkedIn and Twitter. Additionally email-marketing tools may be integrated within the profile, thereby allowing the Merchant to attract potential individual consumers through email. These marketing and promotional tools assist in successfully processing transaction on behalf of the Merchant.

### Process (Marketing and Promotion; Merchant)

Step 1: Once a Merchant profile is created, the system server generates a unique identifier for the individual Merchant (Organization ID) as it relates to marketing and promotion tools to promote the Merchant for transaction processing. As an example, a Social Media plug in tool may be included under each Merchant profile. The system server generates the necessary extensions for each social media platform and inserts said extensions in the correct file for the social media plug-in. As a more specific example: Upon creation of a merchant profile a Facebook extension is created for Merchant promotion through Facebook through “Like” and similar extensions. This extension will automatically create a Facebook post with the Merchant and product/cause information descriptively positioned for “Sharing” and this may include text, images and multiple links.

Step 2: Each Merchant profile has access to an integrated email promotion tool to encourage usage and transactions. Upon completion of a Merchant profile the system server may generate an email portal within the system servers main electronic communication system for use by the specific Merchant. The Merchant accesses the email promotion tool through its online back end (see below). When the Merchant elects to message customers, potential customers and or supporters, the system server generates the “from” email address from the Merchant profile and masks the hard coded “from” email address. The system may include customization of each communication including uploading images, text and other types of media to be inserted in said communication in a standard text or HTML environment. The email communication system will automatically generate individual email communications, with customized greeting for each individual consumer. This data is aggregated from the Merchant profile and customized to the individual consumer through the consumer profile.

Step 3: The system server may also establish a variety of marketing “Buttons” that consist of graphical elements in HTML or similar element or protocol that is linked to a specific web destination when clicked. A library of pre-existing graphical elements are stored locally on the system server. Upon completion of a Merchant profile, the system server aggregating the data from the Merchant profile may automatically insert the destination specific URL link into the HTML code. As an example: The system server will create the HTML link “<a href=‘http://sampleorganization.mycharitybox.staging.push-k.net/’><img src=‘http://sampleorganization.mycharitybox.staging.push-k.net/community/promotion_assets/4.png’/></a>” (a highlighted portion of the HTML indicating the dynamic URL destination generated by the system server for each Merchant profile generated).

Step 4: The present system may also include a reporting mechanism for the Merchant to keep track of individual consumer activity and transaction activity, thereby keeping track of sales, donations and the like. This system includes email notifications on activity and online access, to reports to manage the data. The invention further enables the Merchant to manage the invoicing, statements and accounts payable. Automated transaction confirmations may be sent to the individual consumers via email or SMS notification.

### Process (Merchant Back End System)

Step 1: Each Merchant profile created on the system server generates a unique Merchant Back End panel for Profile management, individual consumer (customer) management and Product/Cause management, which will be linked to the individual consumer “Front End”. The Merchant Back End comprises a unique URL for Merchant access and secured login protocol to access, manage and make changes to the Merchant Profile. At the Merchant profile creation stage, the system aggregates a variety of content from the individual Merchant for purposes of creating the Merchant profile. Data includes a unique username and password. Upon completion and submission of this data to the system server and upon system server verification and query return positive, in addition to the Merchant profile being created, a unique URL is generated together with the Merchant profile ID #. This unique address is where the Merchant can enter the back end by supplying its username and password generated at time of Merchant profile creation. (the same is applied to individual consumers when accessing their individual consumer profiles. The system server generates a unique access point with login credentials input at the time of profile creation with the system server following the same logic.

Step 2: Once the Merchant directs its web browser or connected device to the unique URL there is a prompt to enter the unique login credentials. This information is submitted to the system server which queries the data against its database of Merchant Profiles, and once the Merchant account is located and the credentials are verified, the system server responds with an acceptance of the credentials and access is granted.

Step 3: The system server generates a multitude of content and data and displays such elements on the backend system. This data is aggregated from the Merchant Profile and positioned into the dynamic data sections.

Step 4: Reporting. Each Merchant Profile has access to profile data as it relates to transactions, individual consumer profiles and product/cause data.

Step 4.1: Alternatively reporting is effected when a transaction is completed through the individual consumer Front End system. Each transaction has a unique identifier through the cause/product where the transaction has been completed. These unique identifiers include both the Organization ID #, the Cause/Product identifier and the Consumer Profile ID #. This combination of data creates a “file” within the Merchant Profile for Reporting purposes. The Merchant accesses the Reporting module through its unique Merchant Back end. The Merchant creates a query(s) through the module, which is relayed to the system server. The system server generates the reporting based on the criteria of the query from its main databases, organizing the data for presentation and export by the Merchant.

Step 5: Creation of Product/Cause. The Merchant has the capability of generating a new Product or Cause through dynamic creation on the system server through the Merchant Back End. The Merchant accesses the destination folders, e.g. Cause, through the Merchant Back End, The Merchant generates the Cause by completing a data collection form with information including, cause name, value, promotional text, promotional graphics and additional elements and criteria to position the cause. Upon data entry the system server creates a dynamic sub-folder within the Merchant profile to accept payments/transactions. This sub folder generates a unique URL associated with said cause of said Merchant Profile. This collective data is positioned on the individual consumer front end. Each time a transaction is generated through the specific Cause sub folder, the data is collected and stored to the unique cause and is generated to the Merchant profile through its identifying unique URL and cause subfolder. This data is made available to the Merchant through its Back End System.

Step 6: The individual Merchant can also manage certain components of individual consumer profiles for customer management purposes. This includes contact details. The Merchant generates a data sheet of its registered individual consumer profiles by querying the system server through a contact management module. This query is passed to the system server, generating the matching individual consumer profiles and is displayed in corresponding fields for access and export.

The present system supports one time, recurring and time based transactions. This is especially relevant when processing Micro Payments and transactions.

### Individual Consumer

### Process (Individual Consumer Transaction Processing)

Step 1: The individual consumer accesses the Merchant Front End through the web or a connected device, with each Front End being a sub domain of the system server. The consumer selects the Cause or Product the consumer wishes to support or purchase. Once the Cause or Product is selected, the consumer can select from multiple actions to complete the transaction. An express option generates a form(s), with fields to collect billing information such as card number, type and billing/shipping addresses. Once the information is collected and submitted, the system server send a request to a payment gateway to verify and complete the transaction. Upon completion of the verification, the gateway responds with an authorization code, which signifies the completion of the transaction. The consumers are notified of the transaction's success and the transaction details including authorization code is displayed.

Step 1A: An alternative method to complete the transaction is by creating an individual consumer profile. When this option is selected, the server system generates a form(s) with fields to collect data including card number, type and billing/shipping addresses. Once the information is collected and submitted, the system server sends a request to a payment gateway to verify the billing information and to create a unique account number for future transactions. Once the verification process is complete, the payment gateway returns a verification, which is displayed to the individual consumer. Additionally, a unique consumer account # is provided and the system server creates an individual consumer profile which is stored locally. This profile contains a payment gateway ID for future reference on future transactions.

Step 2: In either scenario of Step 1 or Step 1A, when the individual consumer completes the transaction(s) and receives the authorization code back from the payment gateway, through the system server, an electronic receipt is generated by the system server, with the transaction details including the authorization code, transaction amount and Merchant profile information. This data is aggregated from the Merchant profile on the system server and the individual consumer profile, on the system server. Simultaneously the system server generates a transaction summary, which is forwarded electronically to the merchant. The data is aggregated from both the individual consumer profile and the Merchant profile.

### Process (Recurring Payments)

Step 1: Upon creation of an individual consumer profile, a unique identifying profile ID # is generated. As the consumer profile contains billing data, including a valid method of processing a transaction, e.g. credit card or electronic bank withdrawal profile, the system server supports recurring payments.

Step 2: A recurring payment can be processed through the management of the individual consumer profile. The consumer can select the criteria for the recurring payment information e.g., $10.00 per month. Upon submission of the desired recurring payment criteria the server system queries the payment gateway through API passing through both the unique ID # for the consumer and the payment gateway ID # for its corresponding payment profile. The payment gateway authorizes the recurring transaction, creates an automated recurring billing profile and returns, via API to the system server, the Authorization code. Subsequent management, editing or deletion of the recurring payment system follows the identical process.

The present system enables the consumer to process a micro deposit/payment or transaction either through an Express Module that requires financial date to be entered and is processed immediately for the amount requested. Alternatively the individual consumer can create a payment profile enabling quick process transactions in the future, without the need for re-entering data. This process also enables the individual consumer to set a daily micro deposit or transaction on a recurring schedule with a set goal amount for when the transaction will actually be processed. This process will deposit the set amount into the individual consumers receptacle e.g., the individual consumer can select to deposit/pay $0.25 daily with a goal of $5.00. Each day the receptacle and profile will increase by $0.25 and, once the goal of $5.00 is reached, the transaction in toto will be processed. The present system is also configured to remind the individual consumer to process a transaction, support a “cause” or purchase a “product” through the payment platform. In addition the individual consumer has access to content and new “Cause” and “Product” information as it becomes available through a messaging center on the platform. A full accounting system is also available to keep track of spending and transactions, which can be accessed at any time.

### Process (Micro Deposit System)

Step 1: When an individual consumer initiates session, micro depositing capabilities are enabled. Each Merchant can create a Cause or Product by creating a sub folder with unique identifiers for the specific cause or product. The individual consumer when accessing said cause or product could create a further sub-folder or extension to the Merchant and its specific cause or product. The individual consumer accesses their individual consumer profile with unique login credentials (SEE ABOVE MERCHANT BACK END STEP 1) the individual consumer selects the micro deposit criteria e.g., $0.10 per 24 hour period. These funds are deposited based on these criteria in a “piggy bank” or sub-folder and/or extension for the Merchant profile and the sub folder for the specific cause or product. Furthermore the individual consumer specifies the “Goal Amount” or desired value of the sub folder or extension balance to be processed on their desired method or payment in their individual consumer profile. Upon submission of this data to the system server, a sub-folder and or extension is created for the Merchant profile with the specific cause or product and the individual consumer ID # and criteria of the micro deposit. This data is visible and can be managed by both the Merchant through its Back End System or the individual Consumer through the Merchant profile.

Step 2: Once the Goal Amount level is reached, the system server generates a transaction completion request via API to the Payment Gateway which uses an identifier for the Individual Consumer, Merchant Profile and Payment Gateway ID for authorization. Reporting, and electronic communication and information for the transaction follows the standard process for transaction processing for the system server.

### Accessibility

Accessibility for both the Merchant and Individual Consumer is provided. The individual consumer can process a transaction from mobile devices, social media platforms and the web. In the scenario where a profile for the individual consumer is created, the ability to switch from one platform to another is possible, thereby giving the flexibility to transact in the environment the individual consumers finds themselves in. For example, an individual consumer can purchase a “Product” on his/her mobile device and then support a “Cause” from his/her desktop PC without the need of re-entering data or creating a new profile. The Merchant can interact with individual consumers in each of these environments, creating a more accessible transaction procedure and ensuring the transaction is processed in the most accessible and convenient manner for the consumer. In addition manual transaction processing procedures are made available to assist the Merchant in offline transaction e.g., phone based and mail based transaction processing.

### Process (Individual Applications)

Step 1: The main system server creates a specific web application for each Merchant Profile that is created. The content and specifics surrounding the individual Merchant and the corresponding front end that is accessed by the individual consumer is generated form data on the Merchant Profile that is displayed in the appropriate fields. In addition there is applications on a variety of additional mobile and social media platforms around the main system server. When an individual application is accessed by an individual consumer to process a transaction or to interact the logic follows the same procedure the system server through the individual Merchant profile accesses and displays the relevant data in its appropriate field by accessing said data from the Merchant profile. e.g. the iPhone OS application connects via an API to the system server applies the Merchant ID # and the query is returned with the relevant data for the Merchant.

Step 2: the individual consumer with the following overall process accesses the individual applications. The individual consumer accesses the Merchant profile via his/her connected device or social media platform by inputting the unique URL for the Merchant that accesses the sub-folder of the server system for that Merchant. The system server is queried by the landing page or application via API for the Merchant profile data to be displayed. Once the individual consumer interacts with the application(s) e.g. through a transaction, the system server follows the same process as through the web application applying the Merchant Profile ID # and the individual consumer ID # to the transaction.

### Token

The optional “Token” currency system includes graphic elements that represent a pre-determined dollar amount or value. This form of currency is designed to create a more meaningful experience for the individual consumer while completing virtual experiences.

### Process (Token System)

Step 1: Each Unique Merchant profile can create a sub-folder and or extension for individual Causes or Products. These individual Causes or Products can be created around specific criteria including content description, supporting media files and more, stored locally on the system server and accessed via the system server by the Merchant Profile ID #. Included in this process is the Tokens System.

Step 2: Tokens are graphical elements with a value associated with it. These graphical Tokens are used in place of actual currency when purchasing product or supporting a cause. The system server allows the individual consumer to “deposit” a Token into his/her receptacle, for a desired product or cause, by dragging and dropping the token onto the receptacle on the graphic interface. The system server accesses the dollar value of the Token and applies the corresponding amount to the transaction protocol detailed above instead of entering a dollar amount manually.

Step 3: The individual Merchant creates a Token for Individual Causes or Products through the Back End System. Once the Merchant enters the Token Module the system server provides it with a library of preset tokens or the option to “Create a New Token. In this case the Merchant can submit data for a new token such as token name, description, and image for the token. Once the Token is submitted the system server generates a Token ID # with the content stored, e.g., image and token value.

Step 4: When the individual Merchant creates a new Cause or Product (see above) it can select a Token for its profile to be applied to the individual product or cause. This Token is selected from the library of Tokens stored on the system server under the Merchant Profile.

Step 5: When an individual consumer interacts or desires to process a transaction for a Merchant's cause or product and the Token is used, the system will generate the pre-programmed value of said Token to the individual consumers transaction for settlement.

### Back End Application (System Administrator)

This back end for the system administrator is where the entire technology is managed and the following is an outline of this management function.

The back end of the system has the ability, in non-limiting examples, to perform the following functions.
A. Setting up a new Merchant profile. This process can be manually set by the system administrator or by the Merchant creating the profile through an online widget or similar procedures. A unique URL, marketing materials and a unique system ID, are generated automatically.
B. Creating package levels for the Merchants to choose from, e.g. $100 for the Bronze package, which includes additional features or capabilities.
   a. Package Contents
      i. Services Provided
      ii. Additional Features
      iii. Pricing Schedules
C. Create Pricing Schedules
   a. Pricing
   b. Promotional/Coupon code
D. Manage Available Marketing Tools
   a. Management if collateral for use by the Merchant to promote the system.
E. Distribution Management
   a. Distribution of funds to individual Merchant accounts from processed and approved individual transactions.
   b. Statement Creation for individual Merchant accounts
F. Receptacle Management
   a. Goal amount editing and management
   b. Multiple cause management
G. Individual Consumer Management
   a. Profile Rules
H. Product Creation
   a. Ability to create new products in a white label environment for 3^{rd} party companies to access the core platform under an alternative name or branding experience
I. Communication Management
   a. Email communication to Merchants
   b. Email communications to Individual Consumers

### Back end Application (Merchant)

This is where the Merchant manages its profile, transactions, and individual consumers and can manually process offline transactions.
A. Manage Account Information
   a. Contact data
   b. Banking/Merchant ID (deposit) data
B. “Cause” and/or “Product” data
   a. Create New “Cause” and/or “Product”
      i. Set Cause Name
      ii. Descriptions
      iii. Supporting Content
      iv. Goal Data (e.g., amount, date or on-going)
   b. Manage “Cause” and/or “Product” performance
   c. Start or stop “Cause” and/or “Product”
C. Marketing Tools
   a. Access a library of pre-programmed marketing tools for web promotion
   b. Social Media share tools (e.g., Facebook, Twitter and LinkedIn)
   c. Email Invitations to Individual Consumer
      i. Marketing Emails
      ii. Upload Contacts from Email Account
      iii. New “Cause” and/or “Product” Emails
      iv. General Newsletter Style
D. Reporting
   a. Transaction
   b. Individual Consumers
   c. “Cause” and/or “Product” Performance
   d. Export to XSL, PDF and XML Feed
E. Invoice/Statements Management
   a. Create new statements/invoices for individual consumers
   b. Send statements/invoices to individual consumers via email
   c. Print accounts receivables
   d. Export to XSL, PDF and XML Feed

### Front End Application (Individual Consumer)

An outline where the consumers interact with the system is as follows:
A. Home Page
   a. General Branding for Merchant
   b. Featured Section
      i. “Products” or “Causes”
      ii. News and Blog Updates
      iii. Video and Photo Content
   c. Express Transaction Processing
      i. Process Transaction without creating a profile
   d. Featured Product On A Countdown
      i. “Groupon” Style utility
   e. Social Media Feeds (RSS)
   f. Social Media Share Options
   g. Create a Profile
B. “Cause” or “Product” Page
   a. Multiple Causes
      i. Individual Page for each “Cause” or “Product”
         1. Custom Receptacle
         2. Custom Pricing for “Cause” or “Product”
         3. Custom Graphic Background
   b. Recurring Payments
      i. Settings to Manage Transactions
      ii. My Goal Settings
      iii. Personal Email Reminder Settings
C. History of Transaction
   a. Export to XSL, PDF and XML Feed
   b. Re-Email Service
   c. Transaction Details
D. Profile Management
   a. Personal Data Management
   b. Billing Data Management

With specific reference to FIG. 1, the system 1 is operably accessible with a web or other electronic connected device (i.e., across all available electronic communication systems and platforms) as in step 10 once the system is made operable. Steps involved in setting up the system are controlled with a system server 20, which creates Merchant profiles and applies unique identification in step 21. An electronic ACH Deposit Banking System in step 22 is established with the system entry by a Merchant of Billing/Banking Data in step 11. The system server 20 then creates and provides the Merchant with a unique URL, step 12 which is activated with a quick setup wizard in step 13. The various “products” or “causes” of the Merchant are created in step 14 and the Merchant adds the system to its website at step 15. Thereafter, the Merchant markets the system online at step 16 via, for example, the web, social media, mobile web, iPhone App add mobile App, steps 16a-e for the purpose of consumers buying products or supporting causes of the Merchant.

From the individual or customer side, an individual consumer profile is created for access to the system, step 40 and the individual accesses the Merchant website/marketing tools for effecting the product buying or support of the causes, step 41. The validated consumer or individual 18 accesses the system at any time for the making of donations, payments, and micro donations for buying products or supporting causes at step 17 across platforms 17a-17e, which mirrors the online system access portals 16a-16e

Funds cumulated or as full payments or donations for causes are electronically transferred from the customer or a stored site to the Merchant at step 30, to complete a transaction, defined as a payment, deposit or donation.

It is understood that the above description and examples are illustrative of the invention with changes being possible in set up and operating procedures and protocols and the like without departing from the scope of the present invention as defined by the following claims.

What is claimed is:

1. A system configured for the making of payments or donation over multiple platform electronic communication systems, the system comprising the participants of a recipient Merchant, a system server with system administrator and a consumer making payments or donations to the Merchant,
the system comprising a front end relationship between the Merchant and the consumer and a back end relationship between the Merchant and the system server, wherein the back end of the system comprises elements for the Merchant to provide billing and banking data to the system server and wherein the system server in turn creates and provides the Merchant with a unique URL for a web site,
wherein at least one of donation causes for donation thereto and available purchasable products, is made available on the web site for access by the consumer and
wherein the front end of the system comprises elements to enable the Merchant to promote the system on the web site via any of web, social media, mobile web, iPhone App and mobile App platforms for use by the consumer for making donations or payments with electronic transmissions to the Merchant with any one of the web, social media, mobile web, iPhone App and mobile App platforms,
wherein the consumer provides information to create a profile on the system server to authorize and enable the consumer to access the Merchant web site for utilization of the platforms for making donations and payments and
wherein, with predetermined criteria being reached, the system server causes funds donated or payment funds made by the consumer to be electronically transferred to the Merchant.

2. The system of claim 1, wherein micro donations in amounts of up to a predetermined amount are cumulated by the system server in a virtual money receptacle and wherein when the predetermined amount is reached, the system server causes the cumulated funds to be electronically transferred to the Merchant.

3. The system of claim 1, wherein the back end relationship includes integral elements configured to enable the Merchant to conduct any of the procedures of accounting, marketing and reporting as applicable to the payments and donations and to the transfer of funds to the Merchant.

4. The system of claim 2, wherein the system comprises virtual token emulation configured to permit the consumer to make micro donations across any of the platforms with virtual tokens to simulate donating with coins or other currency.

5. A method of setting up and operating the system of claim 1, comprising the steps of:
setting up an on line web site for a Merchant with configuring the system for accounting and marketing capabilities for use by the Merchant, as well as periodic or on demand reporting,
enabling consumers, clients or customers to become authorized users of the system to make electronic donations and payments across multiple platforms,
providing for cumulation of donation micro deposits, and
transferring of funds and cumulated funds to the Merchant upon the reaching of predetermined criteria.
